(19) United States
(12) Patent Application Publication
(10) Pub. No.: US 2005/0178920 A1
(43) Pub. Date: Aug. 18, 2005

(54) Spacecraft propulsion system

(76) Inventor: Thomas R. Wilson, Anchorage, AK (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/834,681

(22) Filed: Apr. 29, 2004

Related U.S. Application Data
(63) Continuation-in-part of application No. 10/057,507, filed on Jan. 22, 2002, now abandoned.

(51) Int. Cl. B64G 1/40

(52) U.S. Cl. 244/172

(57) ABSTRACT

A spacecraft is disclosed. The spacecraft (10) includes a pressure hull (12) for containing a gas (13). The spacecraft further includes a propulsion system (18) coupled to the pressure hull so as to be disposed within the pressure hull, the propulsion system operable to generate a propulsion force for propelling the spacecraft through space.

### CROSS-REFERENCE TO RELATED APPLICATION

This application is a continuation-in-part application which claims the benefit under 35 U.S.C. § 120 of U.S. patent application Ser. No. 10/057,507, filed Jan. 22, 2002, the disclosure of which is hereby expressly incorporated by reference.

### FIELD OF THE INVENTION

This invention generally relates to spacecrafts, and more specifically to spacecraft propulsion systems for accelerating the spacecraft.

### BACKGROUND OF THE INVENTION

Spacecraft have been and are currently driven by chemical rockets and ion drive propulsion systems, and there are realistic proposals for solar sails and other untried exotic notions. Rockets and ion engines are limited in the overall velocity they can impart to the spacecraft by the mass of the vessel and by the size of the spacecraft's fuel supply. Once the fuel supply is exhausted, the spacecraft is unable to accelerate, decelerate or alter course except by the planned interaction with large gravitational fields.

Space missions are thus constrained because they exhaust their fuel supply into space as the fuel supply is burned and expelled. This constrains space missions to only minimal consumptive trajectories. Further, the mass of the spacecraft must be reduced to the absolute minimum and missions timed to coincide with launch windows which can be years apart.

Solar sails offer one solution, since the fuel supply is not consumed. However, solar sails cannot tack and therefore may only be used for propulsion in one direction, that is away from the sun.

Thus, there exists a need for a faster and more versatile spacecraft for transportation around the solar system that utilizes solar energy and can use a replenishable fuel supply. Accordingly, there exists a need for a spacecraft having a propulsion system that does not expel its products of combustion into space and that is operable to recapture and recycle the propulsion system's reaction products for use over and over again. Further, there exists a need for a spacecraft having a propulsion system disposed within a pressure hull such that the exhaust of the propulsion system is recaptured and recycled. This allows numerous engagements of the propulsion system to cause acceleration, deceleration, and course changes as well as the ability to land on and launch from various solid bodies within our solar system as the fuel supply is replenishable.

### SUMMARY OF THE INVENTION

One embodiment of a spacecraft formed in accordance with the present invention is provided. The spacecraft includes a pressure hull for containing a gas. The spacecraft further includes a propulsion system coupled to the pressure hull so as to be disposed within the pressure hull, the propulsion system operable to generate a propulsive force and transfer the propulsive force to the pressure hull to propel the spacecraft through space.

Another embodiment of a vehicle formed in accordance with the present invention is provided. The vehicle includes a hull for containing a gas within the hull at a selected pressure above an ambient pressure surrounding the hull. The vehicle further includes a propulsion system disposed within and coupled to the hull, the propulsion system operable to accelerate a portion of the gas disposed in the hull to generate a propulsion force for accelerating the vehicle in a selected direction.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a cross-sectional view of one embodiment of a spacecraft formed in accordance with the present invention showing a propulsion system disposed within a pressure hull; and

FIG. 2 is a diagrammatic view of one embodiment of a propulsion system formed in accordance with the present invention and suitable for use with the spacecraft depicted in FIG. 1.

### DETAILED DESCRIPTION OF THE PREFERRED EMBODIMENT

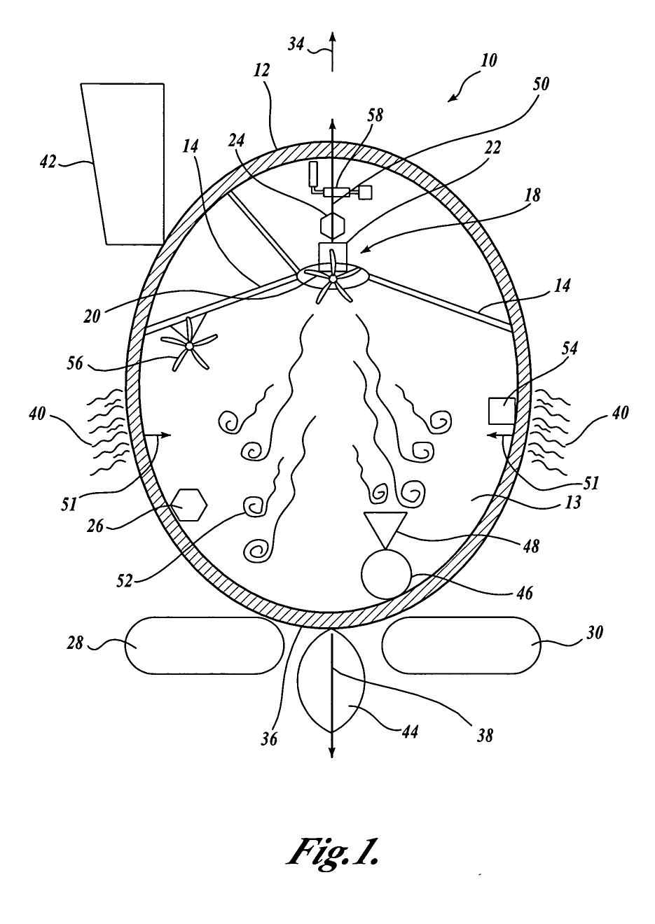

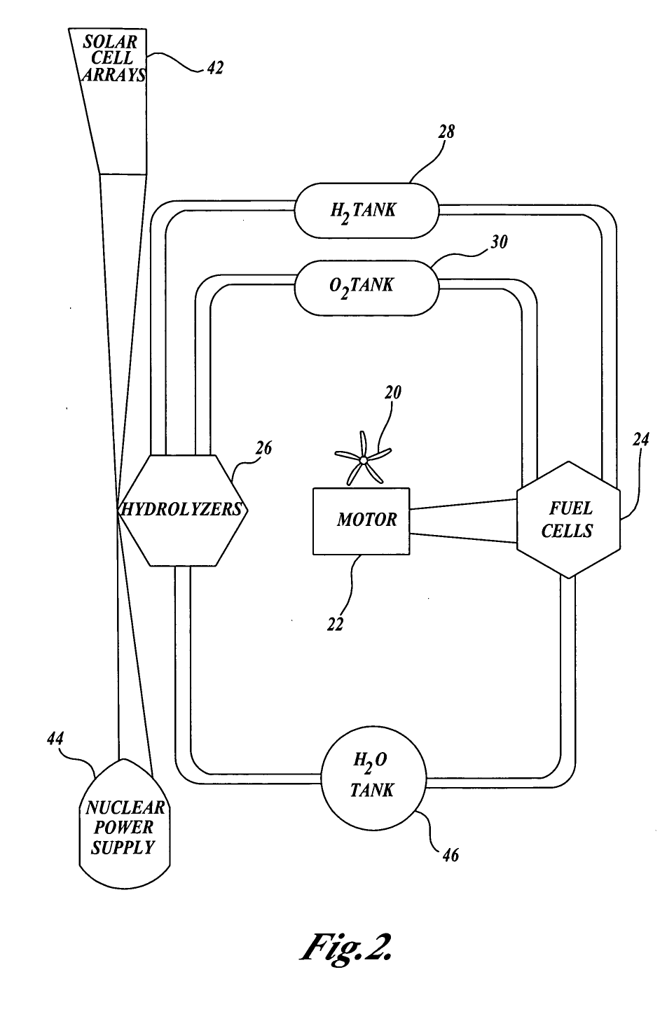

Referring to FIGS. 1 and 2, one embodiment of a spacecraft 10 formed in accordance with the present invention is depicted. The spacecraft includes a hull 12, which is preferably a pressure hull able to withstand a pressure differential between the outer surface and inner surface of the hull 12. The hull 12 of the illustrated embodiment is preferably spherical or egg shaped and constructed to withstand an atmospheric pressure differential of about one atmosphere between the pressure of the surrounding ambient atmosphere and the pressure within the hull. The hull 12 is designed to contain a fluid 13, one suitable example being air. The pressure hull may be built-up of layers of fabric, composites, foam and structural elements sufficient to contain the pressure gradient across the hull's wall.

The spacecraft 10 includes a propulsion system 18 disposed within and rigidly coupled to the pressure hull 12. Preferably, the propulsion system 18 is of a reaction or jet based propulsion system, a few suitable examples being propulsion systems using rockets, aero-thermodynamic-ducts (athodyds), turbojets, ram jets, pulse jets, gas turbines, turbo/ram jets, turbo-rockets, and driven propellers. In the illustrated embodiment, the propulsion system 18 includes a pair of counter rotating propellers or rotors 20 coupled to a driving motor(s) or engine assembly 22. The driving motor(s) or engine assembly 22 are attached to the hull 12 with struts 14, supports, pylons, cables, straps, lines, etc.

The spacecraft 10 further includes fuel cells 24 which are used to convert stored hydrogen and oxygen fuel into electricity for powering the driving motor(s) or engine assembly 22, and in the process, producing a recyclable water byproduct. The spacecraft 10 additionally includes hydrolysers 26 employing electrolysis for splitting the recyclable water byproduct back into its molecular constituent parts of hydrogen and oxygen for use in the fuel cells 24. The spacecraft 10 also includes hydrogen and oxygen storage tanks 28 and 30 adapted to store hydrogen and oxygen for use in the fuel cells 24.

The spacecraft 10 also includes solar cells 42 coupled to the exterior of the hull 12. The solar cells 42 are able to absorb light and convert the light into electricity for use in powering the hydrolysers 26 and other components of the spacecraft 10 as needed. The spacecraft 10 may also include other power generation devices, either in lieu of or in addition to the solar cells 42, such a nuclear power supply 44.

The spacecraft 10 may further include water storage tanks 46 for storing the recyclable water byproduct produced by the fuel cells 24. Additionally, the spacecraft 10 may include a water vapor condensing system 48. The water vapor condensing system 48 is operable to condense water vapor present in the gas 13 in the hull 12 into water, which may be stored in the water storage tanks 46.

The spacecraft 10 may additionally include a cooling system 54 for cooling the gas 13 present in the hull 12. The cooling system 54 is used to control pressure build-up by removing heat generated from the operation of the motors, fuel cells and other ship systems. Any known or to be developed heat transfer system may be utilized for this purpose.

Controlling the direction of flight, that is, navigating the spacecraft 10 may be accomplished in several ways. The preferred embodiment to control, maneuver and navigate is to utilize a navigating system employing a plurality of smaller gimbaled motor propeller assemblies 56 (one shown) which may be located near the inside wall of the hull 12 or on the struts 14. These additional propeller assemblies 56 may also be used to add forward momentum to the spacecraft 10 as well as for re-orienting and for slow speed maneuvering when properly directed.

Although the illustrated and described embodiment includes electric motor driven propellers assemblies 56 for use in causing course changes of the spacecraft 10, alternate navigating systems are suitable for use with and are within the spirit and scope of the present invention. For instance, substituting for or backing up the smaller gimbaled propeller units may be a gyroscopic directional control and stabilizing network 58 similar to that found on the Hubble Space Telescope. This gyroscopic network 58 would need to be scaled to a sufficient size to turn the entire mass of the spaceship 10 even during full power operation of the propulsion system 18.

Further, the navigating system may include, either substituting for or backing up the above described gimbaled motor propeller assemblies 56 or said gyroscopic network 58, H₂ and O₂ burning gimbaled thrusters within and attached to said hull 12 or said struts 14. These H₂ and O₂ burning gimbaled thrusters would then require some means to condense the water vapor and remove un-burnt fuels from the internal atmosphere, such as the water vapor condensing system 48 described above.

In light of the above description of the components of the spacecraft 10, the operation of the spacecraft 10 will now be discussed. The pair of counter rotating propellers 20 are rapidly spun in opposite directions to generate thrust, that is a propulsive force 50. The counter rotating propellers 20 are preferably centered on the fore and aft center axis of the spacecraft 10. The purpose of using counter-rotating propellers 20 is to balance out the gyroscopic precession or torque that the operation of a single motor propeller unit would cause.

In the vacuum of space, there is no air for a spinning propeller to generate aerodynamic lift, that is a propulsive force. However, in the illustrated spacecraft 10, the propulsion system 18 is disposed inside a pressure hull 12 having a gas 13 disposed therein, the gas permitting the propeller to generate its propulsive force.

The pressure hull 12 is of sufficient size to allow the propeller wash 52 to adequately randomize. The predetermined size or more accurately, the volume of the hull 12, is sufficient to allow the randomization of the propeller wash 52 through formation of eddies and vortices, and conversion of some of the inertia of the gas into heat 40. Thus, the randomization and turbulence of the propeller wash 52 and conversion of a portion of the inertia into heat 40 reduces a counter force 38 representing the resultant impact of the propeller wash produced on a back wall 36 of the hull 12.

More specifically, assume a propulsion system 18 is used that is able to generate a 10,000 lbf gross propulsion force 50 tending to move the spacecraft 10 in a forward direction 34. The propeller wash 52 generated by the propulsion system 18 is directed towards the back wall 36 of the hull 12. Upon impacting the back wall 36, a counter force 38 is generated opposite to the propulsion force 50. However, due to the loss of inertia due the formation of turbulence, eddies, and vortices, and conversion to Brownian motion that is heat 40, and due to the randomization of the propeller wash 52 causing some of the gas to impact opposite sidewalls, resulting in sideforces 51 which cancel each other out, the magnitude of the counter force 38 is less than the 10,000 lbf propulsion force 50. For instance, the counter force 38 may be of a magnitude of 8,500 lbf, thereby resulting in a net propulsion force of 1,500 lbf. Although inefficient, and therefore representing a less desirable implementation for use in viscous environments, such as within the earth's atmosphere, the propulsion system 18 of the illustrated embodiment is able to produce forward thrust sufficient to propel the spacecraft 10 forward, especially through the frictionless void of space, without violating the laws of physics. Further, since the fuel supply is replenishable through the use of the solar cells 42 and/or the nuclear power supply 44, the length of the mission of the spacecraft is not limited by the amount of fuel initially loaded upon the spacecraft 10 at launch.

Moreover, the propulsion system 18 is preferably powered by a closed cycle energy source. The closed cycle nature of the fuel system permits the generation of greater velocities and longer duration flights than current fuel expending chemical rockets. Starting at a low energy state where all of the hydrogen and oxygen are locked up as water, the water is fed to hydrolysers 24, wherein electrolysis is performed upon the water using electricity produced by the external solar cells 42 and/or the nuclear power supply 44, thereby splitting the water into its hydrogen and oxygen components. The hydrogen and oxygen are then stored in tanks 28 and 30, ballonets or in external cryogenic liquid containers for later consumption. To drive the spaceship 10, the H₂ and O₂ are fed to the fuel cells 24 which generate electricity sufficient to operate the propulsion system 18 while oxidizing the fuel to water which is piped to storage.

The electricity produced in the fuel cells 24 powers the propellers 20, while the water is later recycled through the hydrolyser 26. In the hydrolyser 26, electricity gathered by the external solar cells 42, which can be supplemented with electric power from the nuclear power supply 44, is used to electrolyze (i.e. split) the water back into its constituent parts, hydrogen and oxygen for reuse.

Alternately, the solar cells 42 and/or the nuclear power supply 44 may power directly the engine assembly 22, thereby eliminating the need for the hydrolysers 24, tanks 28 and 30, and fuel cells 24.

Although the illustrated and described embodiment includes electric motor driven propellers, alternate propulsion systems are suitable for use and within the spirit and scope of the present invention. For instance, the propulsion system may include a jet turbine propeller, such as a turbo-prop that burns H₂ and O₂ fuel. This may achieve higher power at lower weight but would necessitate the installation of significantly greater means to cool the interior atmosphere, as well as means to condense and collect the water vapor in the atmosphere and an additional means to collect un-burnt fuels so as to prevent the build up of explosive levels of such blow-by fuel gases.

Further, the propulsion system may include a H₂ and O₂ burning rocket engine(s). Again this would achieve greater momentary thrust but would significantly increase the residual heat and pressure within the contained atmosphere and would demand even greater means for the previously mentioned cooling, condensation and explosive gas removal.

Further, although the storage tanks of the above described embodiment are illustrated and described as storing H₂ and O₂ in a gaseous state, it should be apparent to those skilled in the art that the H₂ and O₂ may be stored in other states, such as a liquid state. Moreover, the H₂ and O₂ may be stored as liquid in pressurized tanks disposed externally relative to the hull. Producing these cryogenic liquids would involve a second stage of energy use from said solar cells and/or said nuclear power supply to cool and pressurize the gases to a cryogenic liquid state. The use of this system may be used to help in cooling and condensation as required in the turbo-prop or the rocket main drive configurations described above.

Further, although the above described embodiments have been described as used for space transportation, other variations are possible. For example, structuring the spacecraft as a lifting body for aerodynamic flight, re-entry and/or aero-braking are within the spirit and scope of the present invention. Another example would be smaller un-manned configurations for placing or retrieving satellites, probes or other objects.

While the preferred embodiment of the invention has been illustrated and described, it will be appreciated that various changes can be made therein without departing from the spirit and scope of the invention.

1. A spacecraft comprising:
(a) a pressure hull for containing a gas; and
(b) a propulsion system coupled to the pressure hull so as to be disposed within the pressure hull, the propulsion system operable to generate a propulsion force and transfer the propulsion force to the hull to propel the spacecraft through space.

2. The spacecraft of claim 1, wherein the propulsion system includes a propeller coupled to a drive source, the drive source operable to rotate the propeller to generate the propulsion force.

3. The spacecraft of Claim i, wherein the propulsion system includes a pair of counter rotating propellers coupled to a drive source, the drive source operable to rotate the counter rotating propellers to generate the propulsion force.

4. The spacecraft of claim 1, wherein the propulsion system includes a jet turbine engine or a rocket engine.

5. The spacecraft of claim 4, wherein the jet turbine engine or rocket engine burns hydrogen and oxygen.

6. The spacecraft of claim 1, wherein the pressure hull is able to withstand at least about an atmosphere pressure differential.

7. The spacecraft of claim 1, wherein at least a portion of the propulsion system is rotatably coupled to the pressure hull such that a direction of the propulsion force generated by the propulsion system may be angularly adjusted.

8. The spacecraft of claim 1, wherein the propulsion system includes an electric motor for driving a propeller to generate the propulsion force.

9. The spacecraft of claim 1, further including solar panels coupled to the pressure hull, the solar panels adapted to generate electricity for use in powering the propulsion system.

10. The spacecraft of claim 1, wherein the pressure hull is of a predetermined volume selected to permit randomization of motion of the portion of the gas and conversion of inertia of the portion of the gas to heat.

11. The spacecraft of claim 1, where the propulsion system includes a closed cycle hydrogen and oxygen system as a fuel source.

12. The spacecraft of claim 11, wherein the closed cycle hydrogen and oxygen system includes a hydrolyser for electrolyzing water into separate hydrogen and oxygen molecules.

13. A spacecraft comprising:
(a) a hull for containing a gas within the hull at a selected pressure above an ambient pressure surrounding the hull; and
(b) a propulsion system disposed within and coupled to the hull, the propulsion system operable to generate a propulsion force for accelerating the vehicle in a selected direction.

14. The spacecraft of claim 13, wherein the propulsion system includes a propeller coupled to a drive source, the drive source operable to rotate the propeller to generate the propulsion force.

15. The spacecraft of claim 13, wherein the propulsion system includes a jet turbine engine or a rocket engine.

16. The spacecraft of claim 15, wherein the jet turbine engine or rocket engine burns hydrogen and oxygen.

17. The spacecraft of claim 13, wherein the hull is able to withstand at least about an atmosphere pressure differential.

18. The spacecraft of claim 13, wherein at least a portion of the propulsion system is rotatably coupled to the hull such that a direction of the propulsion force generated by the propulsion system may be angularly adjusted.

19. The spacecraft of claim 13, wherein the propulsion system includes an electric motor for driving a propeller to generate the propulsion force.

20. The spacecraft of claim 13, further including solar panels coupled to the hull, the solar panels adapted to generate electricity for use in the propulsion system.

21. The spacecraft of claim 13, wherein the hull is of a predetermined volume selected to permit randomization of a portion of the gas accelerated by the propulsion system and conversion of inertia of the portion of the gas to heat.

22. The spacecraft of claim 13, where the propulsion system includes a closed cycle hydrogen and oxygen system as a fuel source.

23. The spacecraft of claim 22, wherein the closed cycle hydrogen and oxygen system includes a hydrolyser for electrolyzing water into separate hydrogen and oxygen molecules.
